(19) United States
(12) Patent Application Publication
(10) Pub. No.: US 2011/0262874 A1
(43) Pub. Date: Oct. 27, 2011

(54) CHARCOAL STARTING SYSTEM

(75) Inventor: Mark KRAMINER, Westmont (CA)

(73) Assignee: MARKRAM INDUSTRIES INC., Westmont (CA)

(21) Appl. No.: 13/087,788

(22) Filed: Apr. 15, 2011

Related U.S. Application Data
(60) Provisional application No. 61/324,576, filed on Apr. 15, 2010.
(60) Provisional application No. 61/350,979, filed on Jun. 3, 2010.

(51) Int. Cl. F23N 5/00; A47J 37/07

(52) U.S. Cl. 431/6; 126/25 B

(57) ABSTRACT

A device, method and system is provided for a quick, convenient, reliable, odorless and non-toxic alternative to using bagged charcoal briquettes. No harmful chemicals are used, ensuring a safe product that also will not diminish or alter the unique charcoal flavor of the foods being cooked over the charcoal briquettes. The tedious process of handling the briquettes is eliminated and no additional kindling for lighting is required. The container is placed onto the barbeque grate or other cooking surface and lights the outer package; the contained components provide sufficient heat and robust flames to ignite the briquettes within the package.

### I. CROSS-REFERENCE

This application claims the benefit under 35 U.S.C. 119(e) of U.S. Provisional Patent Application No. 61/324,576, filed Apr. 15, 2010, and of U.S. Provisional Patent Application No. 61/350,979, filed Jun. 3, 2010, the contents of which are hereby incorporated by reference in their entirety.

### II. FIELD

The present subject matter relates to the packaging and usage of charcoal briquettes and fire starters.

### III. BACKGROUND

The outdoor barbeque has become a tradition of cooking and social gatherings in various regions, and particularly in North America. Gas barbeques have gained popularity over the last 20 years, due to their ease of use. However, gas renders the grilled foods with a lack of the unique smell and flavor of charcoal.

For many, cooking with charcoal, and charcoal briquettes remains the staple method of outdoor cooking. Simplicity of cooking with charcoal, the smell of food cooking over an open grill, and the taste of food that was slowly cooked over the red hot embers, are some of the reasons for its continued popularity.

Charcoal is available commercially in several formats, including lump charcoal, charcoal briquettes, and pre-soaked charcoal briquettes.

Lump charcoal typically comprises random sized chunks of pre-burned hardwood. Lump charcoal has the positive element of easy and fast ignition. However, lump charcoal also has the negative element of short life span. After ignition, additional chunks usually need to be added during the cooking process.

Charcoal briquettes are typically uniform sized units made from compressed charred hardwood, or other organic materials. They are an excellent, economical fuel for cooking as they provide consistent heat, and stay lit for a long period of time. However, due to their dense composition, charcoal briquettes are extremely difficult to ignite. Simply lighting with a match does not provide enough energy to ignite the briquettes. Consequently, lighter fluid or other harsh and toxic chemicals are typically used to ignite the briquettes sufficiently for cooking. In addition, these harsh lighting fluids or chemicals leave a residue on the briquettes if not completely burned off. This residue alters the taste of the food as it is cooked, leaving an undesirable flavor. Inevitably, these chemicals deposit a degree of toxicity to the cooked food.

Pre-soaked charcoal briquettes may also be marketed under various names such as “easy lite.” These briquettes have the same composition as untreated charcoal briquettes but are also infused or layered with starter fluid for easier lighting. These fluids create the same toxic problems as described above. In addition, it takes at least thirty minutes for the foul odor to dissipate. Furthermore, even the infusion of these fluids does not eliminate the need for additional starter fluids to be poured onto the briquettes, as with traditional charcoal briquettes, for complete ignition of all briquettes.

Since both lump charcoal and charcoal briquettes are made from organic materials that were previously burned in an oxygen rich environment, they become covered with a sooty black dust. This makes their manual handling undesirable, as the soot and dust invariably stain clothes and/or skin.

Charcoal briquettes are available in bags of between five to forty pounds. These bags can be heavy and awkward to lift and transport. Additionally, the bags only contain charcoal briquettes and not any starter substance. The charcoal briquettes still then need to be transferred from the bag to the grill, which is an extra operation. This operation is messy, awkward, and invariably results in inaccurate quantities of charcoal being distributed.

An additional level of inconvenience is added if the barbeque is in a remote location, or on a vessel, or if only a single barbeque is planned. Each trip requires a bag of charcoal and the sufficient starter substance.

U.S. Patent Application Publication No. 2008/0000467A1 to Dudley et al., for a Disposable charcoal lighting apparatus, hereinafter referred to as “Dudley et al.,” makes use of a molded pulp container. However, Dudley et al. also requires the use of potentially harmful chemicals and additional paperboard material. Additionally, molded pulp is the primary fuel for combustion in Dudley et al., and testing has shown molded pulp as insufficient in igniting charcoal briquettes. Further, Dudley et al. uses the terms ‘charcoal briquettes’ and ‘charcoal’ interchangeably; this is not realistic. The dense nature of briquettes make them more difficult to ignite than lump charcoal and in fact briquettes would not sufficiently ignite using the Dudley et al. design, without added fire starters of some form. Dudley et al. does not provide for additional fire starters, relying only on a paperboard cross for lighting.

Furthermore, it is noted that the container(s) of Dudley et al. rest flat on a surface, thus not allowing sufficient air to flow from beneath the containers. This is critical when using standard charcoal grills that do not have an additional lower level, used for soot to accumulate. This results in slow and poor ignition.

A different method is discussed in U.S. Patent Application Publication No. US2008/0092437A1 to Helms et al., for Combustible packages for containing a fuel source and a fire starter, hereinafter referred to as “Helms et al.” Helms et al. describes a combustible package made from folded paper based material (paperboard or cardboard) with a central channel to allow air passage. Alternative designs suggest possible impregnation of the paper based material with paraffin wax or vegetable oil.

However, the folded seams and creases of the paper of Helms et al. create dust, ash and other contaminants from both the burning paper as well as from the charcoal which would seep out of the container through the folded and perforated seams. At the least, this creates a ‘dirty’ burn, which is not desired.

U.S. Pat. No. 6,328,028 to Cayse et al., hereinafter referred to as “Cayse et al.,” discloses a Self-contained charcoal product, and method. Cayse et al. requires at least removal of a firestarter from the carton, deployment of legs to raise the carton and positioning of the firestarter beneath the carton and between the legs prior to attempted ignition of the carton. Furthermore, tests of the Cayse et al. product were unsuccessful and revealed a number of drawbacks and ineffectualness of the Cayse et al. product and method.

Thus, a clean, portable, efficient and effective charcoal starting system is desired. These and other aspects are detailed in the following description.

### IV. SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect, an ignition starting system is provided, comprising: a one-piece container, a wax coating, and a compressed natural composition housed in the container, where the ignition starting system is self-contained, and where ignition is effected without manual manipulation of the shape of the container.

In another aspect, a method for starting charcoal is provided, comprising: lighting a container, igniting a wax layer, igniting a pellet layer, and igniting a charcoal briquette layer, where lighting of the container is manual and subsequent ignition is automatic or self-ignited, and progresses step-wise within the container.

In yet another aspect, a self-contained device for starting charcoal is provided, comprising: a container comprising a wax layer, a pellet layer, and a charcoal briquette layer.

In a further aspect, an ignition starting system is provided, comprising: unitary container means, wax coating means, and compressed natural composition means, where the ignition starting system is self-contained, and where ignition is effected without manual manipulation of the shape of the container means.

Other aspects of the disclosure are found throughout the specification.

### V. BRIEF DESCRIPTIONS OF DRAWINGS

The drawings depict example designs and features of the subject matter.

FIG. 1 is an illustration of a design, with the components shown in exploded form.

FIG. 2 is an illustration of the design of FIG. 1, with the components shown in assembled form.

FIG. 3 is an illustration of an alternative round design with handle; the design is shown in various orthographic views, in FIGS. 3A, 3B and 3C.

FIG. 4 is an illustration of a ‘tall’ design; the design is shown in various orthographic views, in FIGS. 4A, 4B and 4C.

FIG. 5 is a schematic illustration of the ‘tall’ design of FIG. 4; the design is shown in various orthographic views, in FIGS. 5A, 5B, 5C and 5D.

FIG. 6 illustrates a ‘shorter’ version of the ‘tall’ design shown in FIGS. 4 and 5; the design is shown in various orthographic views, in FIGS. 6A, 6B, 6C and 6D.

FIG. 7 is a schematic illustration of another design; the design is shown in various orthographic views, in FIGS. 7A, 7B, 7C and 7D.

FIG. 8 is an illustration of the design of FIG. 7, in one example of product layout use, and in cross-sectional form, showing the product layout in two different configurations, in FIGS. 8A and 8B.

FIG. 9 is an illustration of potential airflow paths (for example, with respect to the container body, in FIG. 9A, and the container lid, in FIG. 9B) and affected areas of the design shown in FIGS. 7 and 8.

FIG. 10 depicts the product in use, as in a sequence of FIGS. 10(I), 10(II), 10(III).

FIG. 11 illustrates further features of another example container.

### VI. DETAILED DESCRIPTION

### Container Research

### Pulp

The pulp functions as the outer container for the product. Ridges and channels incorporated into the design of the shell not only may make pathways for air circulation during combustion, but also may contribute to structural rigidity so the product can endure shipping and handling.

Depending on the quality, thickness, and density of the final pulp supplier, the design may incorporate an attached lid, affixed in a ‘clamshell’ style. The lid is designed in the clamshell style both to avoid warping during the manufacturing process, and to provide a stable structure for stacking.

When selecting a supplier for the pulp, many different samples were tried in an attempt to study how they burned based on ease of lighting, smoke or smell while burning, and product left over after burning. It was found that some pulp often created an excess of smoke while burning, or broke down too quickly as the pulp was consumed. These materials were often darker in color, similar to natural cardboard, but were further distinguished as generally less dense material vs. thicker material, etc. Accordingly, an optimal pulp composition may be determined. The pulp may comprise a composition of one or more of chemical pulp, brown pulp, dissolving pulp/special alpha, fluff pulp, kraft (sulfate) pulp, market pulp, mechanical pulp, sulfite pulp, unbleached pulp, paper pulp, recycled paper pulp, wood pulp, recycled wood pulp, and other common and non-common natural or synthetic combustible pulps.

### Design

Some of the designs (may, in one embodiment, be viewed as iterations) are discussed below and shown in the figures, demonstrating various aspects of the designs, and progression in the design of the container. As stated, some aspects of the design required passage ways for air to circulate, while being robust enough to withstand to torment of commercial packaging since the pulp is also the outer container.

The pulp container is used to house all the combustible components of the product. This includes compressed wood pellets, charcoal briquette, and a thin coating of paraffin wax. The thickness of the wax coating may be chosen in consideration of the container contents, but typically will not exceed 1 inch. Total weight of the package may be, in one embodiment, approximately 2.5 lbs. Initial testing showed that two pounds of charcoal briquette, over the traditional three pounds used for cooking larger meals, was easier to light consistently given the composition of the components.

After the initial volume and rough dimensions were established to house all the necessary components, the container needed to be optimized to allow for airflow throughout the whole structure, while keeping the charcoal collected as it burned to preserve heat. This is a particular challenge because the manufacturing process used for pulp requires a draft angle in the order of five to seven degrees. To try and maintain an even burning, channels are designed into the structure to allow air circulation, including channels on the bottom surfaces to ensure oxygen is reaching the base of the product as it burns.

The drawings include depictions of various designs.

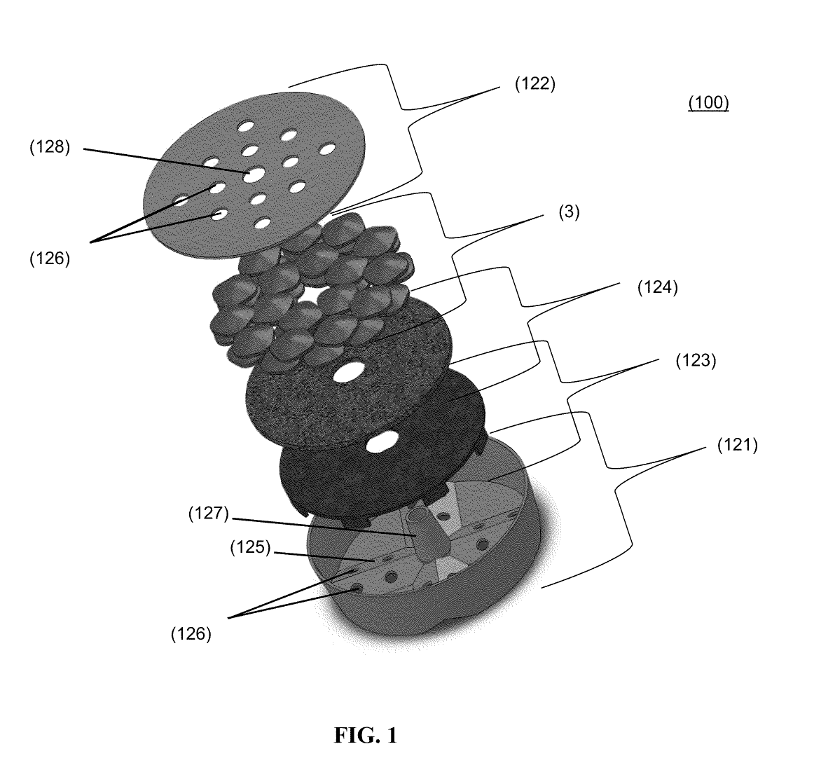

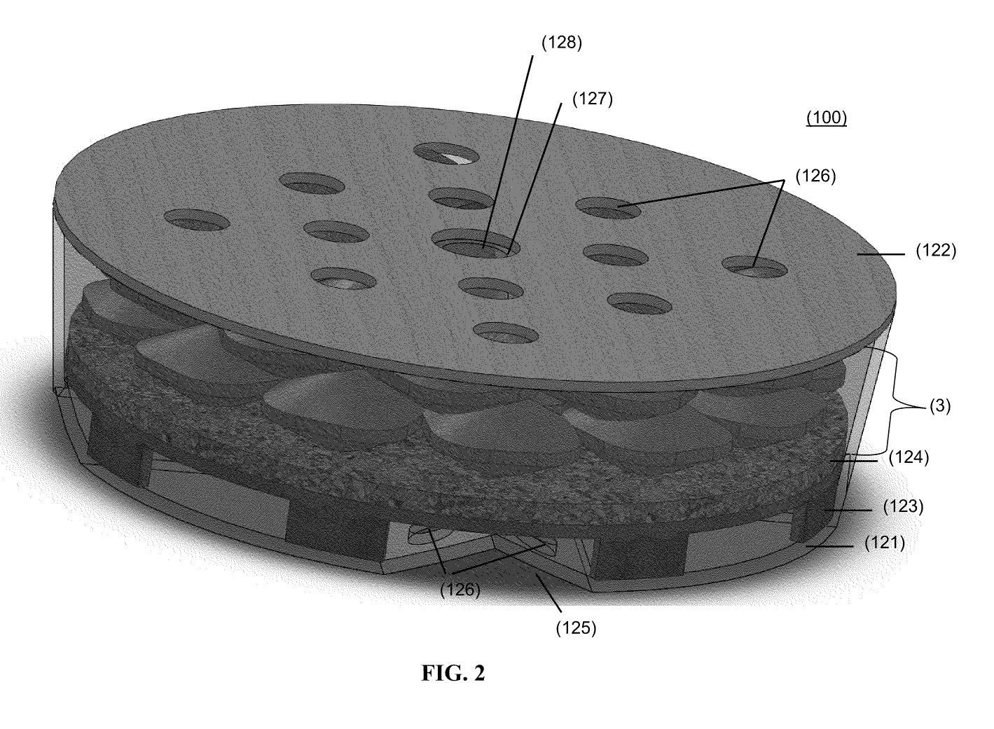

FIGS. 1 and 2 depict a first design concept, in exploded and assembled component form, respectively. This round, short design (100) comprises a two-part pulp construction, of a base (121) and lid (122), with a ventilation chimney (127) running up the center ventilation passage (128) and channels (125) and holes (126) cut/cast into the base (121) and lid (122). The number and placement of the channels (125) and holes (126), may, of course be optional or varied depending on the size and shape of the base (121) and lid (122). The lid (122) may also be optional, depending on the environment of use. This design may also include, in one embodiment, one or more additional cardboard layers inside the container (not shown in FIGS. 1 and 2; an additional cardboard layer may, for example, be between charcoal (3) and lid (122), or may be between each of the layers) to keep pellets and debris from the charcoal spilling out during transportation and handling or to further regulate the resulting burn. This design may be distinguished by the number of additional components required (beyond the base and lid) and the interlocking base components.

As shown in FIGS. 1 and 2, layer (123) locks into base (121), and layer (124) provides a level surface on which the charcoal (3) is spread out. The ventilation chimney (127) also interlocks with each of the layers (123) and (124) (and any optional intermediate cardboard layers), and placement of the charcoal (3) and lid (122) so as to not obstruct the ventilation passage (128). Each of the channels (125), holes (126), ventilation chimney (127) and ventilation passage (128) enhance and facilitate appropriate airflow throughout the base (121) and is assisted by the fit of the layers with each other and of the lid (122) on the base (121). Ignition is effected without manual manipulation of the shape of the container or need for kindling.

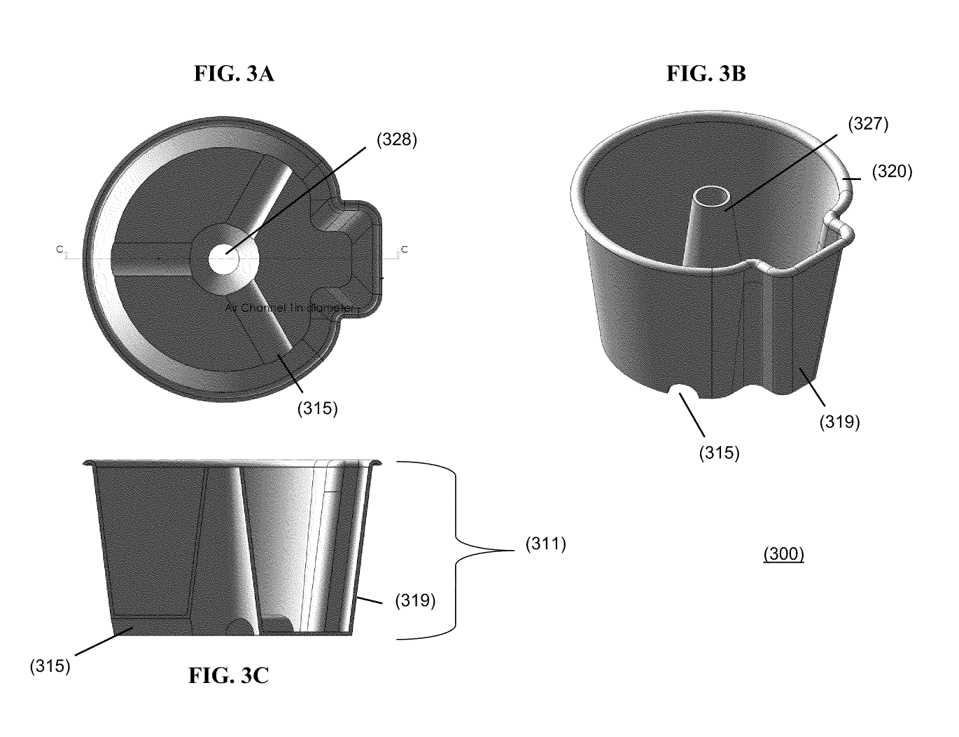

FIG. 3 depicts features similar to the design described in FIGS. 1 and 2 and other design(s), including the ventilation chimney (327) to effect a ventilation passage (328), air channels (315) in the base (311) of the structure, and the requirement for a two-part pulp construction (lid is not shown). Additionally, the side of the container (300) was designed with a handle contour (319) to improve handling and perception of the product. This design (300) may be distinguished by its perceived molding complexity, and the use of the central ventilation chimney/passage (327)/(328). The features may be seen in a top view FIG. 3A, perspective view FIG. 3B, and cross-sectional view FIG. 3C, along lines C-C of FIG. 3A. The design (300) of FIG. 3 and design (100) of FIGS. 1 and 2 may share common content components, and the lid (122) of the design (100) of FIG. 1 may be used, with optional modification, as a venting cover for the design (300) of FIG. 3. While FIG. 3 and FIGS. 1 and 2 both have air channels (315), (125), respectively, in the base of the structure, FIG. 3 does not include venting holes in the base (311). In this manner, the design (300) encourages hot air to rise, promoting continued ignition and combustion. A rim (320) is also provided, which is not only aesthetically pleasing, but also functional, in enhancing the structural integrity of the design package (300). The rim (320) is shown in rolled form, but may also be pressed, flat, chamfered, etc. The base (311) may be layered with combustible contents as described with respect to (100), or in alternate manners. Ignition is effected without manual manipulation of the shape of the container or need for kindling.

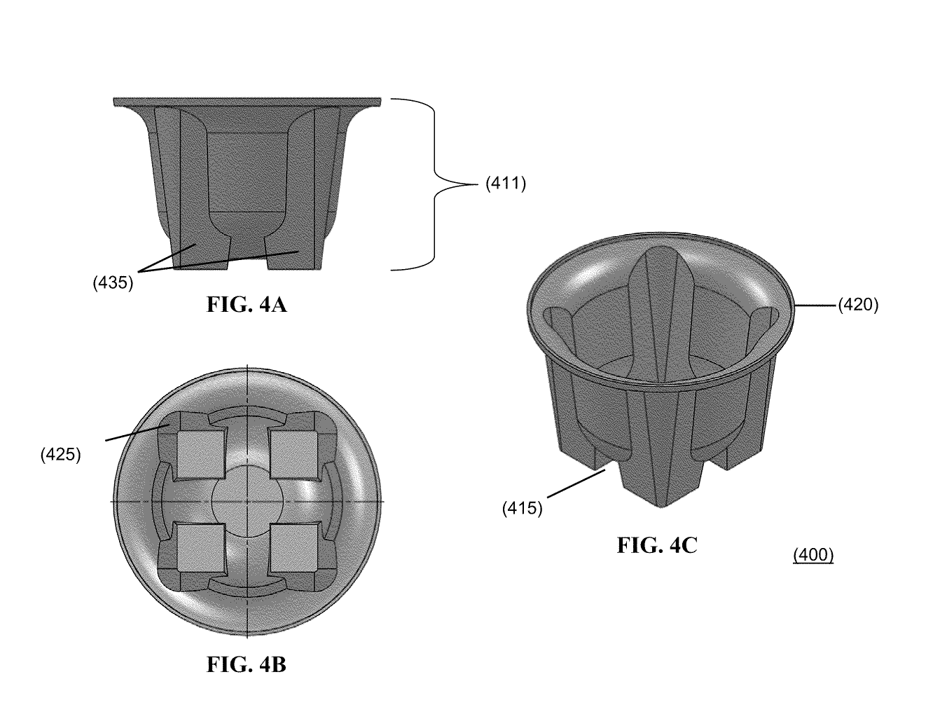

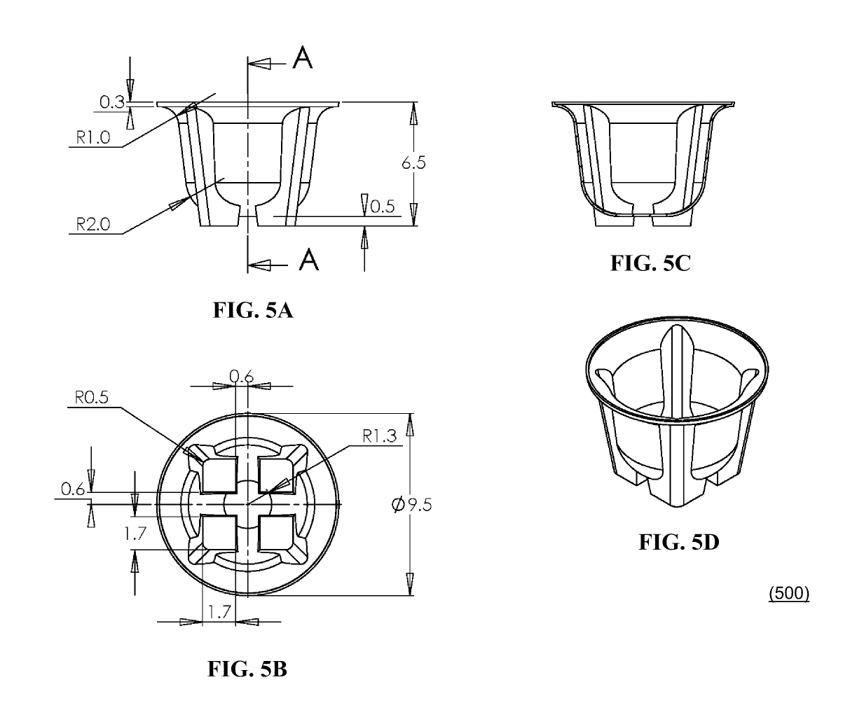

FIGS. 4 and 5 depict a “tall” design (400) which relocates the central ventilation from the middle of the base (411), to be re-distributed amongst the four corners (425) of the package. The four posts (435) allow air to circulate to the base (411), by creating air channels (415). This design also requires a two-part pulp design (lid is not shown). This design may be distinguished by its flower-pot appearance and two-part design. Although the package is shown with four corners in FIG. 4, any number of corners may be used, to enhance or optimize air flow to/from the base, limited only by any manufacturing and structural considerations, in tandem with the size of the package. A rim (420) is also provided, which is not only aesthetically pleasing, but also functional, in enhancing the structural integrity of the design package (300). The rim (420) is shown in pressed form, but may also be rolled, flat, chamfered, etc. The features may be seen in a side view 4A, bottom view FIG. 4B, and perspective view 4C. Ignition is effected without manual manipulation of the shape of the container or need for kindling.

Sample dimensions of an embodiment (500) of the design are provided in the schematic shown in FIG. 5, of a side view FIG. 5A, bottom view FIG. 5B, cross-sectional view FIG. 5C, taken across line A-A of FIG. 5A, and perspective view FIG. 5D. The design may, of course, be sized and scaled appropriately, in consideration of the environment of use. Generally, the “tall” design may be characterized by a vertical height of greater than 4.0 inches.

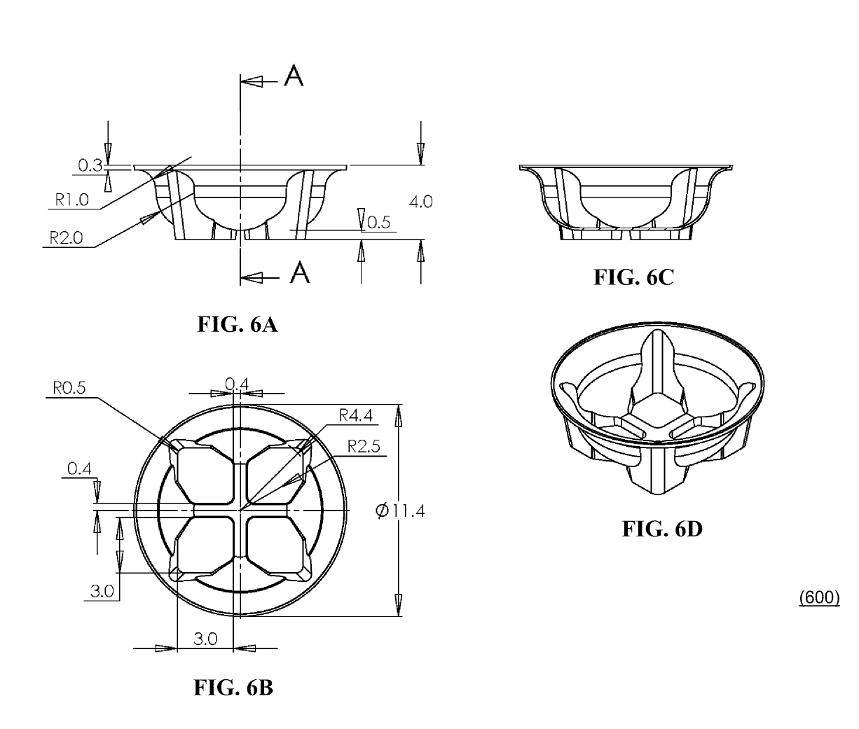

FIG. 6 shows a ‘shorter’ version of the “tall” design of FIGS. 4 and 5. This design may be used, for example, if there are manufacturing limitations from the pulp suppliers with respect to the mold or quantity of pulp available. The ‘shorter’ version may also be useful in cooking environments of limited size, when cooking a smaller amount of food or in consideration of economy in production, cost, storage, the amount of briquettes desired or available and the food available. Ignition is effected without manual manipulation of the shape of the container or need for kindling.

Sample dimensions of an embodiment (600) of the design are provided in the schematic shown in FIG. 6, of a side view FIG. 6A, bottom view FIG. 6B, cross-sectional view FIG. 6C, taken across line A-A of FIG. 6A, and perspective view FIG. 6D. Where features are similar to those discussed with respect to FIGS. 4 and 5, they are not relabeled. The design may, of course, be sized and scaled appropriately, in consideration of the environment of use. Generally, the “shorter” design may be characterized by a vertical height of 4.0 inches or less.

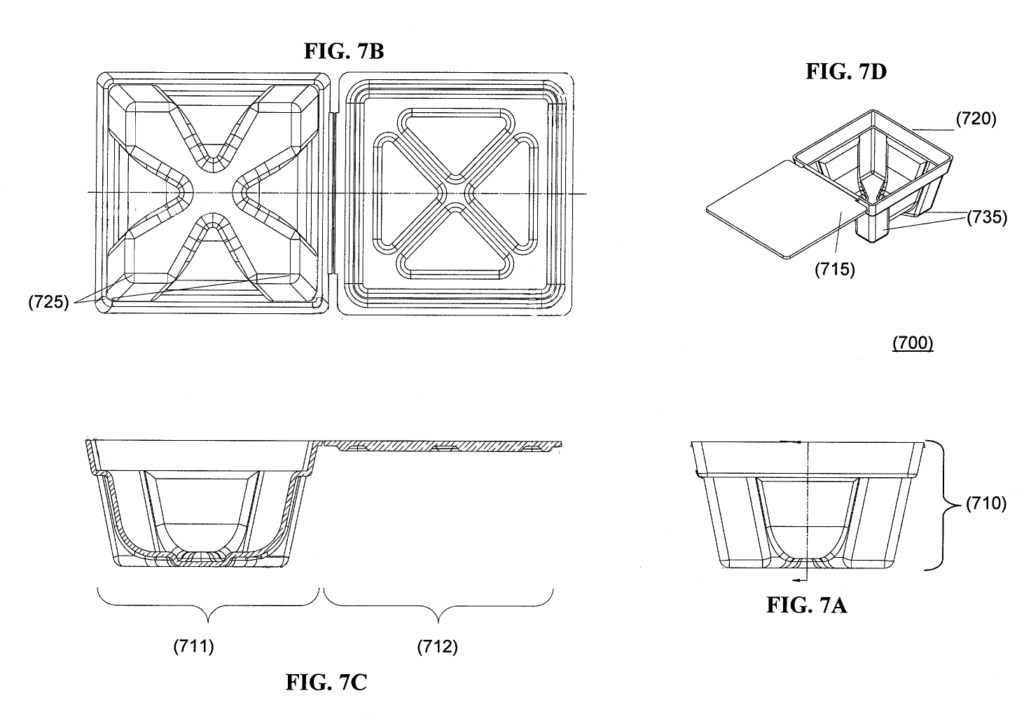

FIG. 7 depicts a schematic of orthographic views of a further design example (700). With respect to FIG. 7, used to make a majority of the manufacturing preparations discussed in the experimental section, the design (700) relocates the central ventilation from the middle, as in other designs, of the base (711), to be re-distributed amongst the four corners (725) of the package (710), comprising the base (711) and the lid (712). The four posts (735) allow air to circulate to the base (711), by creating air channels (715). Thus, the design includes ventilation distributed amongst channels (715) created from the corners so that the geometry and spacing prevents the briquette from blocking those channels.

Although the package is shown with four corners in FIG. 7, any number of corners may be used, to enhance or optimize air flow to/from the base (711), limited only by any manufacturing and structural considerations, in tandem with the size of the package (710). A rim (720) is also provided, which is not only aesthetically pleasing, but also functional, in enhancing the structural integrity of the design package (700). The rim (720) is shown in chamfered form, but may also be rolled, flat, etc. and chosen in a manner to best mate with the lid (712).

The channels and contours also serve to create pathways underneath the container to facilitate the burning. Additionally, this design exhibits a ‘clamshell’ lid system. Accordingly, the package may be created in one-piece, simplifying use and storage of the package. Ignition is effected without manual manipulation of the shape of the container or need for kindling.

Sample dimensions of an embodiment (700) of the design are provided in the schematic shown in FIG. 7, of a front view FIG. 7A, bottom view FIG. 7B, cross-sectional view FIG. 7C, taken across line A-A of FIG. 7A, and perspective view FIG. 7D. The design may, of course, be sized and scaled appropriately, in consideration of the environment of use.

The bracing and contours seen in the lid of the container of FIG. 7 may enhance both the manufacturing process and storage strength. The pulp requires a certain amount of shape and texture to the mold to prevent warping as it dries, which would take away from the fit and appearance of the pulp. This same texture which prevents the warping also acts as ‘ribs’ to add rigidity to the container.

In the interest of production consistency and production in high volumes, the package serves to separate the user from the mess of charcoal briquettes, while containing all the other elements essential for starting a briquette barbeque. The packaging is designed to produce the most efficient burning setup possible for the briquettes. Using channels for air passage and a wide, low profile base to ensure the greatest surface area of the briquette is exposed to flame.

### EXPERIMENTAL DATA

### Using Cayse et al. Product

The product of Cayse et al. was used in a series of test experiments; despite following the instructions, ignition of the Cayse et al. package resulted in a lot of smoke, but very few of the briquettes were ignited. The attempted ignition sequence was as follows: the provided orange starter disc was lit and placed in the center of the grill; after a waiting period of several minutes—until the flame was 3-4 inches high—the box was placed over the flame. The box began to ignite, and the briquettes were exposed to the flames. After about ten minutes, the box was completely collapsed, and many of the briquettes were at the outer perimeter, completely unlit. An attempt was made to salvage the unlit briquettes by re-placing them at the center, close to the flame. After another eight to ten minutes, very few of the re-placed briquettes were ignited, and the temperature was decreasing. This was regarded as a sign of failure of the package.

It is noted that the ignition of the Cayse et al. package was conducted solely as an experiment, and without any ‘actual’ cooking. Thus, it is hard to conceive how the Cayse et al. package may be ignited in a manner sufficient to sustain a flame or temperature for its intended cooking purpose, without additional fire starters. The test showed that the Cayse et al. package did not properly ignite, despite following the teachings of Cayse et al., including waiting longer than thirteen to fifteen minutes for the starter to completely burn, not spreading the coals prematurely, giving the starter adequate time to reach the suggested three to four inch flame height before placing the charcoal box over the ignited starter. It is also noted that spreading the coals may occasionally break up the ignited starter and thus is likely to cause some excessive smoke and that placing the charcoal box over the ignited starter may also contribute to some excessive smoke.

### Using Various Containers Containing Lump Charcoal

Several tests were conducted with deep containers made of medium density cardboard containing two pounds of lump charcoal. Outer containers were then lit with a butane fire starter. The containers disintegrated quickly, causing much smoke, ash and flaking, while igniting few coals.

Several tests were conducted with shallow containers made of medium density cardboard, containing two pounds of lump charcoal. Outer containers were then lit with a butane fire starter. The containers disintegrated quickly, causing much smoke, ash and flaking, while igniting few coals.

Due to the above-described problems with the outer container and negative ignition results, several tests were conducted with containers made of molded pulp only, and then with the introduction of a variety of ignition aides.

Several tests were conducted using shallow containers made of thin, high-density molded pulp, containing two pounds of lump charcoal. The molded pulp container may be chosen in consideration of the desired composition of the container contents and other considerations, but typically will not exceed 3/16 to ½ inch in thickness, and be able to support weights of at least several times its weight. Outer containers were then lit with a butane fire starter. Each time, the container disintegrated quickly, while not igniting many coals. Smoke, flaking and ash were virtually non-existent.

Several tests were conducted using containers made of thick molded pulp of low density, containing two pounds of lump charcoal. The container was difficult to light, took long to burn, and resulted in black smoke and flaky residue, while not igniting many coals.

### Using Various Containers Containing Lump Charcoal and Wood Chips

Several tests were conducted using containers made of thin molded pulp of medium density, containing two pounds of lump charcoal. Two inches of wood chips were poured inside the container, upon which, the usual two pounds of lump charcoal was placed. Outer containers were then lit with a butane fire starter. The wood chips caught fire and helped ignite more, but not all of the coals, before self-extinguishing.

Several tests were conducted using containers made of medium thickness molded pulp of medium density. Two inches of wood chips were poured inside the container, upon which two pounds of lump charcoal was placed. Outer containers were then lit with a butane fire starter. The wood chips caught fire faster and most of the charcoal was ignited before extinguishing. However, smoke and ash was prevalent.

### Using Various Containers Containing Charcoal Briquettes and Wood Chips

Thus, the replacement of lump charcoal with charcoal briquettes may be desired. Briquettes burn longer, and unlike lump charcoal, no replacement briquettes are needed in order to grill a complete meal. In addition, as lump charcoal is made of odd shaped pieces of hardwood remnants, standard size packaging (for a one-time use application) would be all but impossible.

However, a major obstacle to overcome was that briquettes, being much denser than lump charcoal, are extremely hard to ignite. In solving this problem, the potential of wood pellets, a unique and superior heat source was discovered. Pellets are made of compressed sawdust and other biomass materials and burn for a long period and at sustained high heat.

Thus, several tests were conducted using deep containers made of thin, high-density molded pulp. Wood chips were poured inside the container, filling a two-inch cavity. Approximately a quarter pound of pellets were poured into the container and then two pounds of charcoal wood briquettes were added. The outer containers were then lit with a butane fire starter. The containers disintegrated quickly while igniting the wood chips and then a few of the pellets and not many coals. Smoke, flaking and ash were at a minimum.

Using Various Containers Containing Charcoal Briquettes and Wood Chips with Additional Ignition Component(s)

As the outer container/wood chips combination proved to be insufficient to ignite all of the pellets, paraffin wax was introduced as an ignition component.

Several tests were conducted using deep containers made of thin, high-density molded pulp. A thin layer of pre-melted paraffin wax was poured over the inside of the container. Approximately a quarter pound of pellets was poured into the container. Two pounds of charcoal wood briquettes were then added. The outer containers were then lit with a butane fire starter. The container disintegrated quickly, while igniting the paraffin wax. This then successfully ignited the pellets and eventually, most of the coals. Smoke, flaking and ash were virtually non-existent.

Several tests were conducted using deep containers made of thin, high density molded pulp. A thin layer of pre-melted paraffin wax was poured over the inside of the container. Approximately a quarter pound of pellets was poured into the container. Two pounds of charcoal wood briquettes were then added. Additional paraffin wax was then poured over the briquettes. The outer containers were then lit with a butane fire starter. The container disintegrated quickly, while igniting the paraffin wax. The strong high flames of the burning pulp/paraffin ignited the pellets and in turn, the paraffin wax on the briquettes. Eventually, all of the coals were ignited. Smoke, flaking and ash were virtually non-existent.

After the initial volume and rough dimensions were established to house all the necessary components, the container needed to be optimized to allow for airflow throughout the whole structure, while keeping the charcoal collected as it burned to preserve heat. This is a particular challenge because the manufacturing process used for pulp requires a draft angle in the order of five to seven degrees. To try and maintain an even burning, channels are designed into the structure to allow circulation, including channels on the bottom surfaces to ensure oxygen is reaching the base of the product as it burns.

Various trials were carried out to determine the most efficient quantity of each component and effective design(s) and size(s) of the outer container.

### Embodiment 1

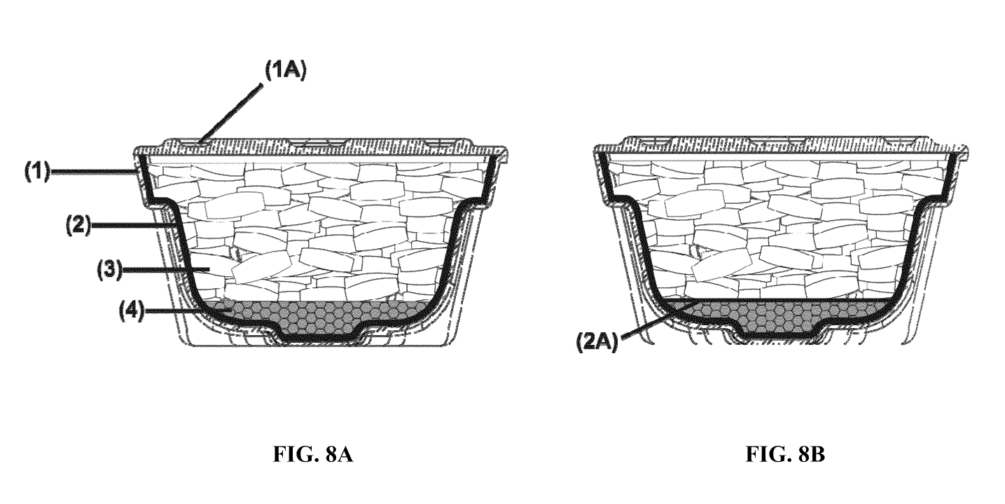

The subject matter illustrated in FIG. 8 comprises untreated charcoal briquettes and three primary ignition components. These components combine to achieve ignition and sustained flames to light the charcoal briquettes.

The primary ignition components include: a) a custom designed molded pulp container and lid made from recycled paper pulp of a thin, high-density composition; b) a paraffin wax coating; and c) compressed wood sawdust or biomass pellets.

The process relies on a chain reaction of combustion of at least these three components. The container (1) is lit, and as it is consumed, the inner components are ignited. The final selection of these components and their specific quantities was made after many hours of trials spanning several months. A variety of candidates, based on their sensory compatibility, ease of ignition, amount of stored energy released during combustions, their economy, and environmental impact were evaluated.

A breakthrough occurred with the idea of using, and the eventual discovery that compressed pellets, a completely natural product, could be used successfully in this application even without a fan system. The specific design and intended use of compressed pellets is as fuel for ‘pellet stoves’. For that use, a fan is required to ignite the pellets. Of course, a fan is not practical in the present subject matter. But the unique structural design of the pulp container, which promotes rapid and efficient burning, together with the strong flames of paraffin wax, has been proven as sufficient to ignite the pellets.

Pellets, in turn, give off sustained flames and high heat. Sustained flames and high heat are required to sufficiently ignite charcoal briquettes, which are the most difficult component to ignite.

The present subject matter is intended as an easier, cleaner, simpler, more environmentally friendly, and sensory pleasing method of charcoal packaging and ignition than bagged charcoal/lighter fluid or chemical alternatives.

FIG. 8 illustrates an example layout used for the subject matter to take full advantage of the chain reaction of combustion. (1) refers to the molded pulp container which is used for the outer container, with (1A) as the lid, which may be of the same or a complementary piece. The surface(s) to which the paraffin wax will be applied is denoted by (2) in FIG. 8A; FIG. 8B shows one of the many possible alternative layouts for the paraffin wax (2A). The charcoal briquettes (3) may be stored in a manner as shown in FIGS. 8A and 8B; the illustrated container may be designed to hold approximately two pounds of charcoal briquettes, although the container may also be manufactured in other sizes. A base layer of compressed wood sawdust or biomass pellets (4) is also provided.

### Embodiment 2

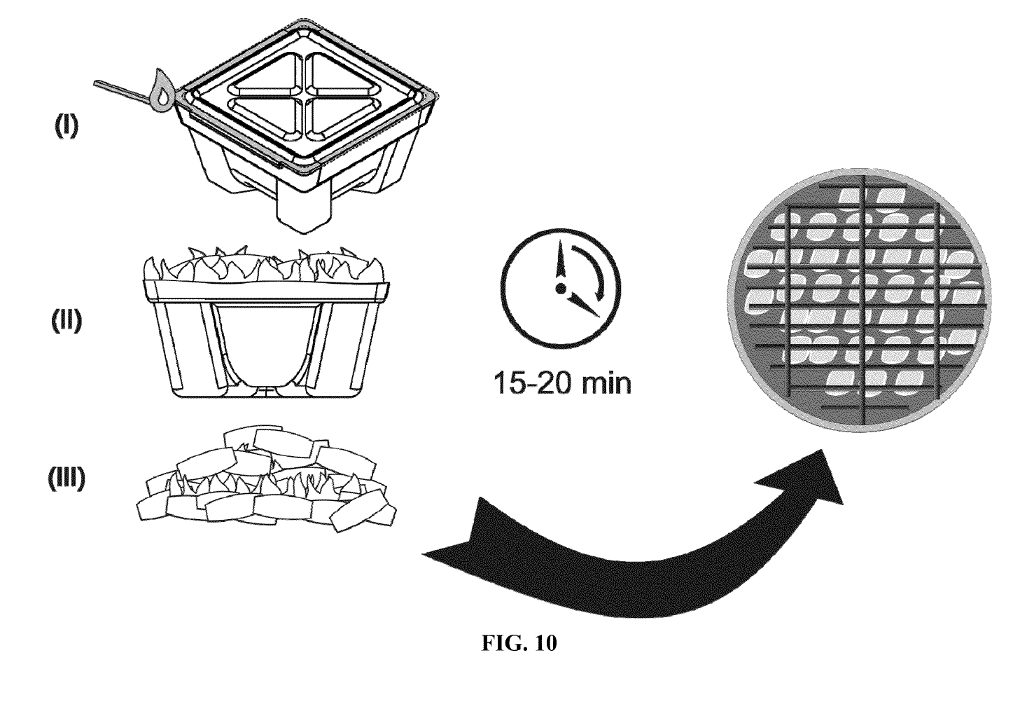

As depicted in FIG. 10, the package may be lit by the user at one of its top edges, as may be suggested by graphical and written instructions on the container. Once lit, the outer package begins burning, which starts a chain reaction of igniting the other contained components. In approximately fifteen to twenty minutes, all of the components are consumed in the combustion, leaving only the red hot charcoal briquettes, which are now ready to be used for grilling.

The ignition chain reaction may occur in the following manner:

As shown in FIG. 10(I), the outer molded pulp container (1), (1A) is lit with a match or other lighting device. As the container burns, as seen in FIG. 10(II), the wax (2) ignites quickly, creating strong, high flames of relatively short duration. These flames together with the still burning outer container succeed in igniting the pellets (4) within a few minutes. It is noted that paraffin wax (2) typically ignites quickly resulting in high flames, but extinguishes soon thereafter, while leaving no residue. Since the pellets (4) consist of compressed wood sawdust or biomass materials, they require strong consistent flames to ignite. Once ignited, the ignited pellets would burn for a sustained period of time. Thus, the strong and long lasting flames from the burning pellets together with remnants of the other still burning components combine to ignite the briquettes (3) to more than fifty percent of their original volume, as shown in FIG. 10(III). This degree of ignition is sufficient for the briquettes to continue self-igniting and soon after, for example in 15-20 minutes, although the specific waiting time may be more or less depending on the size and composition of the container, the cooking process can begin.

### Embodiment 3

The outer container (1) may be made from molded pulp of a thin, dense composition to ensure ideal long lasting burning properties, while also eliminating flaking tendencies of lower density pulps. This container (1) serves as the outer casing of the subject matter. The container (1) is engineered such that the ridges and pockets embossed in the sides and bottom of the container act to channel air through the product during combustion.

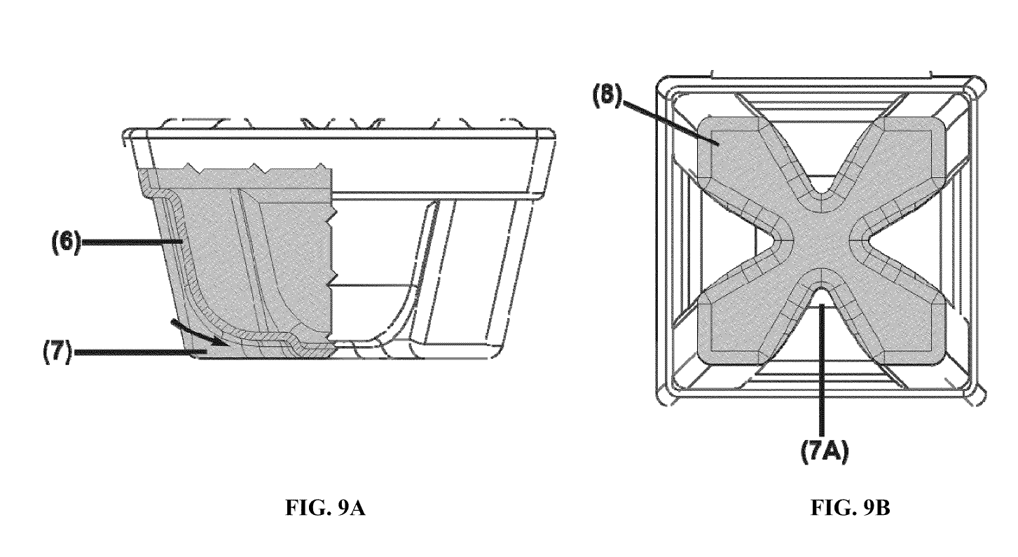

Inside the container (1), channels may be created on the corners of the container by the depressions in the sides of the container. These internal channels (6), by design, prevent briquettes from packing the corners (7) of the container, thus allowing the flow of air to the base (8). The base of the product (8) raises the container off of the surface of the grill, allowing air to travel underneath the container. The air path traveled for full combustion may be seen in FIGS. 9A and 9B, with respect to the container (1) and container bottom (1A), as (7) and (7A), respectively.

### Embodiment 4

Additionally, the container (1) may be designed with a clamshell style lid (1A), having a hinge (10). The lid (1A) may be further embossed or pre-molded with structural ribs (11) which not only help add rigidity to the structure, but also enable the containers to be stacked for storage or display, and encourage airflow and containment of heated air within the container (1) for increased combustion efficiency and effectiveness.

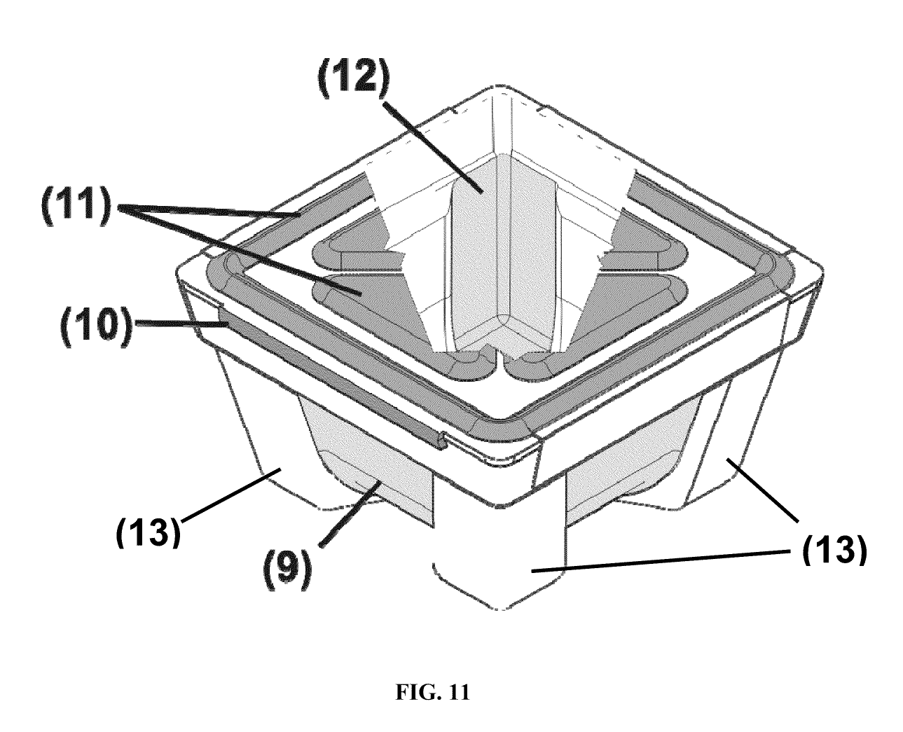

Additional depressions may be also created on/in the container to increase air flow; this may also include depressions (9) on the side of the container, as shown in FIG. 11.

### Embodiment 5

Paraffin wax (2) and (2A) may be applied to the inner surface of the molded pulp container. The wax may be pre-heated in a separate vessel, until it reaches liquid form, and then applied to the inner surface of the container (1), giving it a thin coating. Alternatively, paraffin wax may be applied only over the surface of the pellets as a thin layer, (2A) to aid in ignition; this would also help to secure the pellets during transport and keep them in a compact, controlled form prior to ignition. A combination of both steps may also be used. Paraffin wax is used to control the combustion of the molded pulp and to extend the burning time of the molded pulp, while leaving no residue. Envisioned alternatives to paraffin wax include beeswax, palm wax, soy wax, bone wax, fruit waxes, etc. and other common and non-common natural or synthetic combustible waxes.

The location of the charcoal briquettes within the container is identified as (3) with respect to FIG. 8. In the interest of achieving a ‘natural,’ odor-less and non-toxic ignition, the present subject matter may use, in one envisioned embodiment, natural charcoal briquettes made of compressed charred hardwood, other organic materials, and without the addition of any of the starting chemicals found in alternative ‘instant light’ type briquettes. However, other briquettes of various sizes, shapes and compositions may be substituted in order to achieve an optimal odor-less and non-toxic ignition. One or more aspects of the design of the container (1), (1A), of the present subject matter can also be modified or reconfigured to make use of lump charcoal or other shaped charcoal or components, by resizing the packaging for the increased or other variable volume.

A key ignition component of the present subject matter is compressed pellets made from wood sawdust or biomass materials (4). As discussed, compressed pellets are used because of their combustion properties. Pellets also possess energy density, in that an abundant amount of heat energy is stored within a tiny unit. However, other natural compositions and materials are contemplated, and compressed dusts, pellets, balls or other small-mass cylinders, etc. of various sizes, shapes and compositions, including compressed wood sawdust, biomass pellets, biomass dusts, wood pellets, wood balls, biomass balls, small-mass wood cylinders, small-mass biomass cylinders and other common and non-common combustible compositions, having high energy density may be substituted in order to aid an optimal odor-less and non-toxic ignition.

As discussed above, sufficient air flow around/about the container is critical when using standard charcoal grills that do not have an additional lower level. In grills that have an additional level, the soot may accumulate therein, with less impact to ignition speed and quality. In order to aid air flow, the present subject matter has, in one embodiment, four integrated molded legs (13) which act to raise the container sufficiently to allow proper air flow from beneath the container.

The present subject matter relies on a chain reaction created as the molded pulp container (1), (1A) is consumed, while igniting the paraffin wax (2), (2A), and in turn, the compressed wood sawdust or biomass pellets (3). This differs from previous applications which disclose the use of chemical coatings with additional paper based material (paperboard, cardboard, or newspaper). The present subject matter also avoids the use of potentially harmful chemicals, thus preserving the unique flavor of food cooked over charcoal. Prior applications also call for the use of paper as the initial lighting point. The present subject matter avoids the use of paper in its design, as paper is a source of contamination, at least because paper ash flakes off during and after combustion processes. In contrast, the pulped container enables a safe, effective, clean enclosed burn.

Thus, at minimum, the present subject matter differs in materials, construction, and design, sharing only the suggested use of paraffin wax and air channels. The present subject matter utilizes a chain reaction involving three distinct ignition components including molded pulp as the container (1), (1A). Uniquely, the molded pulp container (1), (1A), enables the design of complex shapes while simultaneously offering structural rigidity. Thus, the present subject matter uses the shape and structure of the molded pulp design in a novel manner to channel the air to the container contents (2), (3), (4), etc. to ensure there is enough oxygen available for complete combustion. Additionally, in the present subject matter the user is completely isolated from contact with the charcoal briquettes or other combustible components. In this manner an effective, clean, non-toxic charcoal starting system is provided.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Of course, those skilled in the art will recognize many modifications may be made to this configuration without departing from the scope or spirit of what is described herein. It will be understood that many additional changes in the details, materials, steps and arrangement of parts, which have been herein described and illustrated to explain the nature of the subject matter, may be made by those skilled in the art within the principle and scope of the disclosure as expressed in the appended claims. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An ignition starting system comprising:
a one-piece container;
a wax coating layer; and
a compressed natural composition housed in the container,
wherein the ignition starting system is self-contained, and
wherein ignition is effected without manual manipulation of the shape of the container.

2. The ignition starting system of claim 1, wherein the container is a molded pulp container of a thin, high-density composition.

3. The ignition starting system of claim 2, wherein the pulp is chosen from the group consisting of: chemical pulp, brown pulp, dissolving pulp/special alpha, fluff pulp, kraft (sulfate) pulp, market pulp, mechanical pulp, sulfite pulp, unbleached pulp, paper pulp, recycled paper pulp, wood pulp, recycled wood pulp, and other common and non-common natural or synthetic combustible pulps.

4. The ignition starting system of claim 1, wherein the wax is chosen from the group consisting of one or more of: paraffin wax, beeswax, palm wax, soy wax, bone wax, fruit waxes, and other common and non-common natural or synthetic combustible waxes.

5. The ignition starting system of claim 1, wherein the compressed natural composition is chosen from the group consisting of one or more of: compressed wood sawdust, biomass pellets, biomass dusts, wood pellets, wood balls, biomass balls, small-mass wood cylinders, small-mass biomass cylinders and other common and non-common high energy density combustible natural compositions.

6. The ignition starting system of claim 1, further comprising a lid.

7. The ignition starting system of claim 1, further comprising charcoal briquettes.

8. The ignition starting system of claim 7, wherein the charcoal briquettes are heated sufficiently to cook with.

9. The ignition starting system of claim 1, the container comprising a plurality of integrated air channels.

10. A method for starting charcoal comprising:
lighting a container;
igniting a wax layer;
igniting a pellet layer; and
igniting a charcoal briquette layer,
wherein lighting of the container is manual and subsequent ignition is automatic or self-ignited, and progresses step-wise within the container.

11. The method of starting charcoal of claim 10, wherein the container is only partially lighted.

12. The method of starting charcoal of claim 10, wherein the ignited charcoal briquettes are heated sufficiently to cook with.

13. A self-contained device for starting charcoal comprising:
a container comprising
a wax layer,
a pellet layer, and
a charcoal briquette layer.

14. The self-contained device for starting charcoal of claim 13, wherein the charcoal briquettes are heated sufficiently to cook with.

15. The self-contained device for starting charcoal of claim 13, further comprising a plurality of integrated air channels.

16. An ignition starting system comprising:
unitary container means;
wax coating means; and
compressed natural composition means housed in the container means,
wherein the ignition starting system is self-contained, and
wherein ignition is effected without manual manipulation of the shape of container means.

17. The ignition starting system of claim 16, further comprising a plurality of air channel means integrated with the container means.

18. A combustible pulp composition, wherein the pulp creates a continuous burn.
